(19) United States
(12) Patent Application Publication
(10) Pub. No.: US 2026/0179468 A1
(43) Pub. Date: Jun. 25, 2026

(54) ABNORMAL EVENT DETECTION SYSTEM, PROCESSING DEVICE AND DETECTION METHOD THEREOF

(71) Applicant: Aurismart Technology Corporation, Taipei City (TW)

(72) Inventors: Kuang-Chiu HUANG, Taipei City (TW); Ching Wei HUANG, Taipei City (TW)

(21) Appl. No.: 19/375,191

(22) Filed: Oct. 30, 2025

Related U.S. Application Data
(60) Provisional application No. 63/737,622, filed on Dec. 21, 2024.

(30) Foreign Application Priority Data
Aug. 1, 2025 (TW) 114129474

(51) Int. Cl. G08B 21/04; G10L 25/51

(52) U.S. Cl. CPC G08B 21/0469; G10L 25/51

(57) ABSTRACT

An abnormal event detection system includes a sound capturing device, an abnormal event processing device, and a warning device. The sound capturing device is configured to capture ambient sounds in an area. The abnormal event processing device is configured to recognize the ambient sounds to determine whether the ambient sounds include at least one first sound category that should not occur in the designated area, and whether the ambient sounds do not include at least one second sound category that should occur in the designated area. When the ambient sounds include the at least one first sound category, or do not include the at least one second sound category, the warning device generates a warning message.

### CROSS-REFERENCE TO RELATED APPLICATION

This application claims priority to U.S. Provisional Application Ser. No. 63/737,622, filed Dec. 21, 2024, and Taiwan Application Serial Number 114129474, filed Aug. 1, 2025, which are herein incorporated by reference in their entirety.

### BACKGROUND

### Technical Field

The present invention relates to a notification system, and more particularly to an abnormal event detection system, a processing device, and a detection method that can detect and identify abnormal events and report them accordingly.

### Description of Related Art

As the current social structure tends to be aging and living alone, how to provide family members with better protection in case of emergency has become an important task.

Traditional emergency assistance services rely on the user to actively trigger an alarm by calling out or pressing an emergency button, or use motion detection or image recognition equipment to detect abnormal movements in order to notify caregivers or relevant personnel. However, relying on the user's active request for help means that once the user loses the ability to act autonomously, the protective function is entirely lost. On the other hand, methods that detect abnormal movements typically require devices to be worn by the user or involve capturing the user's image, which is not only inconvenient but also raises privacy concerns. As a result, such methods cannot provide complete protection for the user.

Therefore, there is an urgent need for an abnormal event detection method and a detection system to provide users with better protection.

### SUMMARY

The foregoing presents a summary of the disclosure in order to provide the reader a basic understanding. Accordingly, this disclosure provides an authorization method, authorization system, and electronic device using.

Consistent with embodiments of the present disclosure, there is provided an abnormal event detection system, comprising a sound capturing device, configured to capture ambient sounds in an area; an abnormal event processing device coupled to the sound capturing device, configured to recognize the ambient sounds to determine whether the ambient sounds include at least one first sound category that should not occur in the area, and whether the ambient sounds do not include at least one second sound category that should occur in the area; and a warning device coupled to the abnormal event processing device, wherein when the ambient sounds include the at least one first sound category or do not include the at least one second sound category, the abnormal event processing device controls the warning device to generate a warning message.

In some embodiments, the warning message is an alarm sound, an alarm text, an alarm image, an alarm vibration or an alarm flash, and wherein the warning device is a speaker for outputting the alarm sound, a screen for displaying the alarm text or the alarm image, a vibrator for outputting the alarm vibration, or an indicator light for emitting the alarm flash.

In some embodiments, the sound capturing device is a microphone.

In some embodiments, the abnormal event processing device further comprises: a sound filtering module coupled to the sound capturing device, configured to receive and filter the ambient sounds to generate filtered ambient sounds; a sound recognition module coupled to the sound filtering module, configured to recognize the filtered ambient sounds to generate a plurality of sound categories; and a sound determination module coupled to the sound recognition module, configured to determine whether the plurality of sound categories include the at least one first sound category, and whether the plurality of sound categories do not include the at least one second sound category.

In some embodiments, the sound determination module is further configured to calculate a cumulative number of occurrences of each of the plurality of sound categories within a time range.

In some embodiments, the time range further comprises a first time range and a second time range, and the sound determination module is further configured to calculate the cumulative number of occurrences of the at least one first sound category within the first time range and the cumulative number of occurrences of the at least one second sound category within the second time range.

In some embodiments, the sound determination module is further configured to determine whether the cumulative number of occurrences of the at least one first sound category within the first time range is greater than a first threshold value; and when the cumulative number of occurrences of the at least one first sound category within the first time range is greater than the first threshold value, the abnormal event processing device controls the warning device to generate the warning message.

In some embodiments, the sound determination module is further configured to determine whether the cumulative number of occurrences of the at least one second sound category within the second time range is less than a second threshold value; and when the cumulative number of occurrences of the at least one second sound category within the second time range is less than the second threshold value, the sound determination module determines that the plurality of sound categories do not include the at least one second sound category, and the abnormal event processing device controls the warning device to generate the warning message.

Consistent with embodiments of the present disclosure, there is provided an abnormal event detection method, comprising: capturing ambient sounds in an area; filtering the ambient sounds to generate filtered ambient sounds; recognizing the filtered ambient sounds to generate a plurality of sound categories; determining whether the plurality of sound categories include at least one first sound category and whether the plurality of sound categories do not include at least one second sound category; and generating a warning message when the plurality of sound categories include the at least one first sound category or do not include the at least one second sound category.

In some embodiments, the abnormal event detection method further comprises calculating a cumulative number of occurrences of each of the plurality of sound categories within a time range.

In some embodiments, the time range further comprises a first time range and a second time range, and the method further comprises calculating the cumulative number of occurrences of the at least one first sound category within the first time range and calculating the cumulative number of occurrences of the at least one second sound category within the second time range.

In some embodiments, the abnormal event detection method further comprises determining whether the cumulative number of occurrences of the at least one first sound category within the first time range is greater than a first threshold value; and generating the warning message when the cumulative number of occurrences of the at least one first sound category within the first time range is greater than the first threshold value.

In some embodiments, the abnormal event detection method further comprises determining whether the cumulative number of occurrences of the at least one second sound category within the second time range is less than a second threshold value; and determining that the plurality of sound categories do not include the at least one second sound category and generating the warning message when the cumulative number of occurrences of the at least one second sound category within the second time range is less than the second threshold value.

Consistent with embodiments of the present disclosure, there is provided an abnormal event processing device, comprising: a storage circuit configured to store a plurality of computer-executable instructions; and a processor electrically coupled to the storage circuit, wherein the processor is configured to retrieve and execute the plurality of computer-executable instructions to: receive ambient sounds in an area; filter the ambient sounds to generate filtered ambient sounds; recognize the filtered ambient sounds to generate a plurality of sound categories; determine whether the plurality of sound categories include at least one first sound category and whether the plurality of sound categories do not include at least one second sound category; and generate a warning message when the plurality of sound categories include the at least one first sound category or do not include the at least one second sound category.

In some embodiments, the processor is further configured to calculate a cumulative number of occurrences of each of the plurality of sound categories within a time range.

In some embodiments, the time range further comprises a first time range and a second time range, and the processor is further configured to calculate the cumulative number of occurrences of the at least one first sound category within the first time range and calculate the cumulative number of occurrences of the at least one second sound category within the second time range.

In some embodiments, the processor is further configured to: determine whether the cumulative number of occurrences of the at least one first sound category within the first time range is greater than a first threshold value; and generate the warning message when the cumulative number of occurrences of the at least one first sound category within the first time range is greater than the first threshold value.

In some embodiments, the processor is further configured to: determine whether the cumulative number of occurrences of the at least one second sound category within the second time range is less than a second threshold value; and determine that the plurality of sound categories do not include the at least one second sound category and generate the warning message when the cumulative number of occurrences of the at least one second sound category within the second time range is less than the second threshold value.

Accordingly, the abnormal event detection system, processing device, and detection method of this invention can determine that a user may be experiencing a sudden incident based on the detection of sound categories that should not occur in the monitored environment, and issue a warning message. Furthermore, when the user encounters a sudden incident, such as falling unconscious and being unable to make sounds or move their limbs, the system can also issue a warning message based on the absence, within a certain time frame, of expected routine sound categories that are typically present in the monitored environment. This allows for more comprehensive protection of the user. Additionally, since the system captures ambient sounds, and sound signals propagate without blind spots, the system can be installed anywhere within the user's environment, thereby providing broader and more effective coverage and protection.

It is to be understood that the foregoing general description and the following detailed description are exemplary and explanatory only and are not restrictive of the disclosed embodiments.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1A illustrates a schematic diagram of an abnormal event detection system according to an embodiment of the present application.

FIG. 1B illustrates a schematic diagram of an abnormal event detection system according to another embodiment of the present disclosure.

FIG. 2 is a schematic diagram of an abnormal event processing device according to an embodiment of the present application.

FIG. 3 is a flowchart illustrating the steps of an abnormal event detection method according to an embodiment of the present application.

### DETAILED DESCRIPTION

In the present disclosure, when an element is referred to as “connected” or “coupled”, it may mean “electrically connected” or “electrically coupled”. “Connected” or “coupled” can also be used to indicate that two or more components operate or interact with each other. In addition, although the terms “first”, “second”, and the like are used in the present disclosure to describe different elements, the terms are used only to distinguish the elements or operations described in the same technical terms. The use of the term is not intended to be a limitation of the present disclosure.

Unless otherwise defined, all terms (including technical and scientific terms) used in the present disclosure have the same meaning as commonly understood by the ordinary skilled person to which the concept of the present invention belongs. It will be further understood that terms (such as those defined in commonly used dictionaries) should be interpreted as having a meaning consistent with its meaning in the related technology and/or the context of this specification and not it should be interpreted in an idealized or overly formal sense, unless it is clearly defined as such in this article.

The terms used in the present disclosure are only used for the purpose of describing specific embodiments and are not intended to limit the embodiments. As used in the present disclosure, the singular forms “a”, “one” and “the” are also intended to include plural forms, unless the context clearly indicates otherwise. It will be further understood that when used in this specification, the terms “comprises (comprising)” and/or “includes (including)” designate the existence of stated features, steps, operations, elements and/or components, but the existence or addition of one or more other features, steps, operations, elements, components, and/or groups thereof are not excluded.

Reference will now be made in detail to exemplary embodiments, discussed with regard to the accompanying drawings. In some instances, the same reference numbers will be used throughout the drawings and the following description to refer to the same or like parts. Unless otherwise stated, technical and/or scientific terms have the meaning commonly understood by one of ordinary skill in the art. The disclosed embodiments are described in sufficient detail to enable those skilled in the art to practice the disclosed embodiments. It is to be understood that other embodiments may be utilized and that changes may be made without departing from the scope of the disclosed embodiments. For example, unless otherwise indicated, method steps disclosed in the figures may be rearranged, combined, or divided without departing from the envisioned embodiments. Similarly, additional steps may be added, or steps may be removed without departing from the envisioned embodiments. Thus, the materials, methods, and examples are illustrative only and are not intended to be necessarily limited.

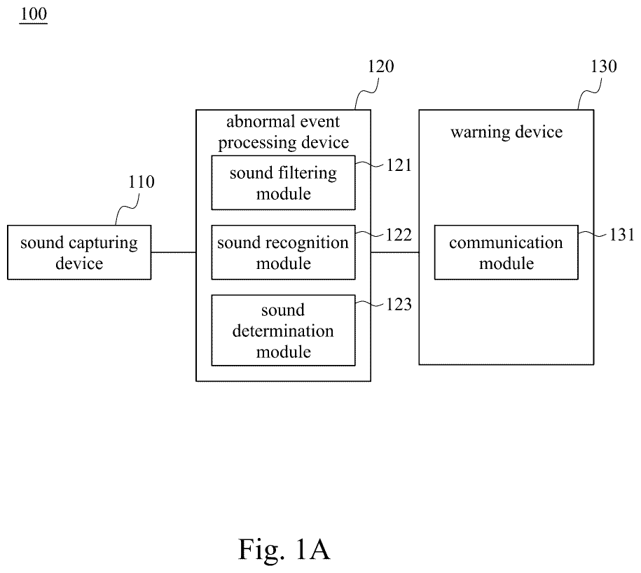

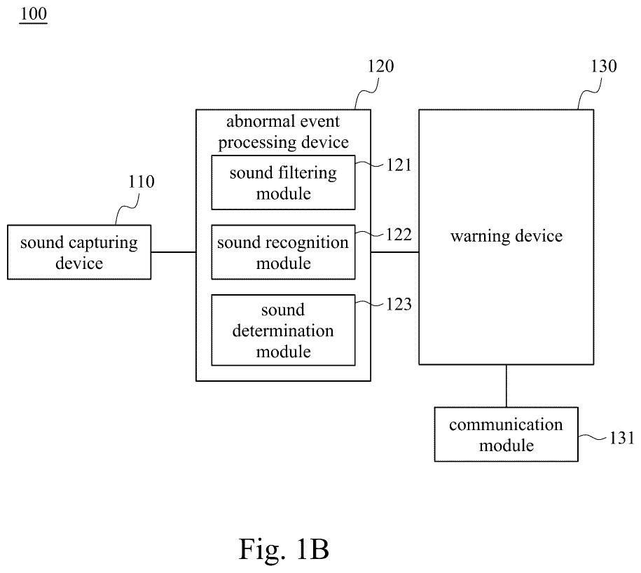

FIG. 1A illustrates a schematic diagram of an abnormal event detection system according to an embodiment of the present disclosure. In some embodiments, the abnormal event detection system 100 is configured to capture ambient sounds and determine whether the ambient sounds contain any abnormal condition sound, so as to trigger a warning device to issue a warning message for notifying caregivers or relevant personnel. Accordingly, the abnormal event detection system 100 includes a sound capturing device 110, an abnormal event processing device 120, and a warning device 130. In some embodiments, the warning message may be an alarm sound, an alarm text, an alarm image, an alarm vibration, or an alarm flash, which is generated by the warning device 130 to notify on-site caregivers or other household members for providing immediate assistance. Accordingly, the warning device 130 may be a speaker configured to generate the alarm sound. The warning device 130 may also be a vibrator for issuing the alarm vibration. The warning device 130 may further be an indicator light for emitting the alarm flash, or a display screen for showing the alarm text or alarm image. In other embodiments, the warning message may further be a warning notification. Therefore, the abnormal event detection system 100 may further include a communication module 131 for transmitting the warning notification to remote relevant personnel to provide immediate assistance. However, the present disclosure is not limited to the above, and notification may also be made based on a predetermined list of recipients according to the type of abnormal event determined. In some embodiments, as shown in FIG. 1A, the communication module 131 is disposed within the warning device 130. In other embodiments, as shown in FIG. 1B, the communication module 131 may be independently configured, such as being disposed outside the warning device 130.

In some embodiments, the sound capturing device 110 may be a microphone configured to capture ambient sounds and transmit them to the abnormal event processing device 120. In application scenarios for emergency protection of family members, the sound capturing device 110 may be disposed in any area within the home, such as the bedroom, the bathroom, the living room, or the kitchen, to capture ambient sounds of the installed area and transmit the captured sounds to the backend abnormal event processing device 120 via wired or wireless transmission. The backend abnormal event processing device 120 determines, based on the captured ambient sounds, whether sounds that are not supposed to occur are present, or whether the expected sounds are absent, in the area where the corresponding sound capturing device 110 is installed.

In some embodiments, the abnormal event processing device 120 is coupled to the sound capturing device 110 and receives the ambient sounds captured by the sound capturing device 110. In some embodiments, to determine whether the ambient sounds include sounds that should not occur or whether the expected sounds that are missing, the abnormal event processing device 120 further includes a sound filtering module 121, a sound recognition module 122, and a sound determination module 123.

The sound filtering module 121 is configured to filter the ambient sounds to extract necessary sounds and provide them to the sound recognition module 122 for recognition. In some embodiments, using a home environment as an example for protecting household members, the necessary sounds are those related to human activities. Taking the ambient sounds in a bathroom as an example, the sounds related to human activities include, but are not limited to, the tooth brushing sound, the shaving sound, the showering sound, flushing the toilet sound, or other activity-generated sounds such as knocking sound, clapping sound, body slapping sound, water flow sound, or footsteps sound. On the other hand, sounds unrelated to human activities include, but are not limited to, the operating noise of an exhaust fan or traffic noise from outside the window. Accordingly, the sound filtering module 121 first filters the ambient sounds to remove sounds unrelated to human activities, such as the exhaust fan noise and traffic noise, from the ambient sounds captured in the bathroom, and then provides the filtered ambient sounds to the sound recognition module 122 for subsequent recognition and classification. However, the present application is not limited to the above embodiment. In other embodiments, the system may be applied in pesticide-free eco-friendly farm environments to provide ambiently friendly monitoring, in which case the necessary sounds to be monitored include not only human voices but also insect sounds indicative of a healthy environment. Accordingly, the sound filtering module 121 filters the ambient sounds to extract human voices and insect sounds and provides them to the subsequent sound recognition module 122 for further recognition and classification. In another embodiment, the system may be applied in factory environments to provide abnormal event monitoring. In such cases, the necessary sounds to be monitored include not only human voices but also warning sounds generated under abnormal conditions, such as fire alarms. Accordingly, the sound filtering module 121 filters the ambient sounds to extract human voices and warning sounds and provides them to the subsequent sound recognition module 122 for further recognition and classification.

The sound recognition module 122 is configured to recognize the ambient sounds filtered by the sound filtering module 121 and to perform classification to classify the recognized ambient sounds to knock sounds, clapping sounds, body slapping sounds, water flow sounds, or footstep sounds. In some embodiments, the sound recognition module 122 may be implemented using an artificial intelligence (AI) model. In such cases, various sound data related to human activities are pre-used as training samples to train the AI model and perform parameter fitting and adjustment. Accordingly, after the training is completed, the trained AI model can recognize the filtered ambient sounds and classify the recognized sounds related to human activities according to the classification criteria used during training, such as knock sounds, clapping sounds, body slapping sounds, water flow sounds, or footstep sounds. However, the classification categories described above are not intended to be limiting. Based on the above, because the present disclosure utilizes the sound filtering module 121 to filter out sounds unrelated to human activities before sound recognition is performed by the sound recognition module 122, the computational burden of sound recognition by the sound recognition module 122 can be reduced, and the classification process can be accelerated.

The sound determination module 123 is configured to perform a comprehensive determination based on various types of human activity-related sounds recognized by the sound recognition module 122, to determine whether any abnormal sound has occurred or whether an expected sound has failed to occur. In some embodiments, taking ambient sounds generated in a bathroom as an example, under normal usage conditions, sounds such as the clapping sound, the body slapping sound, the water flow sound, and the footsteps sound are considered normal sounds, whereas knocking sounds are considered abnormal. Accordingly, the sound determination module 123 may determine whether to send a warning message to the warning device 130 based on the frequency of occurrence of knocking sounds.

In some embodiments, if the sound determination module 123 determines that at least three knocking sounds recognized by the sound recognition module 122 occur within one minute, it may infer that an abnormal condition has occurred. This is because under normal bathroom usage, there should not be knocking sounds resulting from intentional knocking on walls or the floor, especially if such sounds occur continuously within one minute. In such a case, the sound determination module 123 may determine that the bathroom user may have experienced an abnormal event, such as fainting and hitting the ground or wall, thereby generating knocking sounds. As a result, a warning message is sent to the warning device 130 to notify a caregiver or relevant personnel to check on the situation.

In another embodiment, a single care recipient typically uses the bathroom at least once every five hours as part of a regular lifestyle pattern. Therefore, if the sound determination module 123 determines, based on the ambient sounds generated in the bathroom, that no human activity-related sounds—such as clapping, body slapping, water flow, or footsteps—have occurred within five hours, it may determine that the care recipient is experiencing an abnormal condition and is unable to get up to use the bathroom. Consequently, a warning message is sent to the warning device 130 to notify a caregiver or relevant personnel to perform a check.

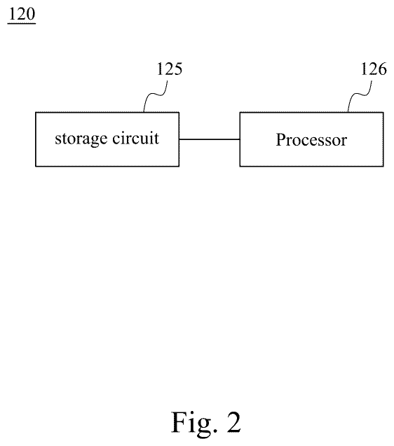

FIG. 2 illustrates a schematic diagram of an abnormal event processing device according to an embodiment of the present disclosure. In some embodiments, the hardware architecture of the abnormal event processing device 120 at least includes a storage circuit 125 and a processor 126. The sound filtering module 121, the sound recognition module 122, and the sound determination module 123 may be implemented as computer programs or instructions stored in the storage circuit 125. These computer programs or instructions are executed by the processor 126 to realize the functionalities of the sound filtering module 121, the sound recognition module 122, and the sound determination module 123. The processor 126 may be composed of one or more chipsets. The storage circuit 125 may be a read-only memory, flash memory, floppy disk, hard disk, optical disk, USB flash drive, magnetic tape, network-accessible database, or any other non-transitory computer-readable recording medium having equivalent functionality as would be readily appreciated by those skilled in the art.

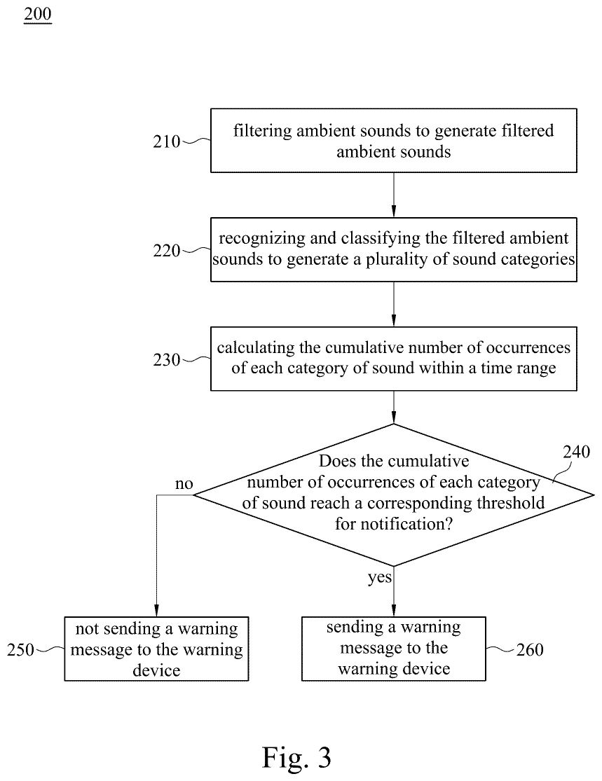

FIG. 3 illustrates a flowchart of an abnormal event detection method according to one embodiment of the present disclosure. In some embodiments, after the processor 126 reads the computer programs or instructions stored in the storage circuit 125, the processor 126 executes the functions of the sound filtering module 121, the sound recognition module 122, and the sound determination module 123 to perform the abnormal event detection method 200. Please also refer to FIGS. 1A, 1B, 2, and 3.

As shown in FIG. 3, step 210 filters ambient sounds to extract necessary sounds therefrom. In some embodiments, the sound capturing device 110 is used to capture ambient sounds of the surrounding environment and transmit them to the abnormal event processing device 120. The sound filtering module 121 in the abnormal event processing device 120 filters out unnecessary sounds from the ambient sounds to extract necessary sounds, for example, sounds related to human activity.

In step 220, the filtered ambient sounds are recognized and classified. In some embodiments, the sound recognition module 122 is configured to recognize and classify the ambient sounds filtered by the sound filtering module 121. In some embodiments, the sound recognition module 122 may be implemented using an artificial intelligence model to perform recognition and classification on the filtered ambient sounds, for example, classifying the recognized sounds as knocking sounds, clapping sounds, slapping sounds, water flow sounds, or footsteps sounds.

In step 230, the cumulative number of occurrences of each category of sound within a time range is calculated. In some embodiments, after the sound recognition module 122 recognizes that the filtered ambient sounds can be classified as knocking sounds, clapping sounds, slapping sounds, water flow sounds, and footsteps, the sound determination module 123 calculates the cumulative number of occurrences of each category of sound within a time range. In some embodiments, the cumulative number of occurrences of each category of sound is calculated based on a sliding window, where the time range of the sliding window is, for example, one minute. That is, along a time axis, the cumulative number of occurrences of each category of sound within a time range is sequentially calculated.

In step 240, it is determined whether the cumulative number of occurrences of each category of sound has reached a corresponding threshold for notification. In some embodiments, after the sound determination module 123 calculates the cumulative number of occurrences of each category of sound within a time range, the sound determination module 123 compares the cumulative number of occurrences of each category of sound with the threshold value of that category to further determine whether a notification should be made. In some embodiments, after the sound determination module 123 calculates the cumulative numbers of occurrences of knocking sounds, clapping sounds, slapping sounds, water flow sounds, and footsteps sounds within a time range, the cumulative number of occurrences of each of these sounds is respectively compared with the preset threshold for knocking sounds, clapping sounds, slapping sounds, water flow sounds, and footsteps sounds. Based on the comparison results, it is determined whether to perform a corresponding notification. If the condition is met, step 260 is executed to send a warning message to the warning device 130; otherwise, step 250 is executed to refrain from sending a warning message to the warning device 130. It should be noted that the above usage scenarios, sound categories, and the settings of cumulative numbers and corresponding thresholds are merely exemplary embodiments and are not intended to limit the present disclosure. The implementer may vary them according to the application environment and application scenario.

In some embodiments, taking as an example the knocking sound recognized from the ambient sounds in a bathroom, since under normal usage conditions, the ambient sounds generated in a bathroom should not include artificially produced knocking sounds on the wall or floor, the present disclosure can set a knocking-sound threshold value of three times per minute. Accordingly, when the sound determination module 123, in step 230, calculates that the cumulative occurrence number of knocking sounds within a one-minute range is four times, and in step 240 determines that the cumulative occurrence number of knocking sounds is greater than the knocking-sound threshold value, it is determined that user in the bathroom may have encountered an abnormal situation. Therefore, step 260 is executed to send a warning message to the warning device 130 to notify the caregiver or relevant unit to check. Conversely, if in step 240 it is determined that the cumulative occurrence number of knocking sounds is not greater than the knocking-sound threshold value, step 250 is executed so that no warning message is sent to the warning device 130.

In another embodiment, it is also possible to determine whether the cared-for person is in a dangerous situation based on whether the cared-for person deviates from his normal living patterns. In one embodiment, if the cared-for person's habitual living pattern is to use the bathroom at least once every five hours, the present disclosure can set the bathroom-usage threshold value as once every five hours. Accordingly, when the sound determination module 123, in step 230, calculates that within five hours the cumulative occurrence number of sounds in the bathroom environment related to human activity, such as clapping sounds, body-slapping sounds, running water sounds, or footsteps sounds, is zero, meaning the bathroom-usage number is zero, then in step 240 it is determined that the cumulative bathroom-usage count is less than the bathroom-usage threshold value. Thus, the sound determination module 123 determines that the cared-for person may have encountered an abnormal situation, and therefore in step 260 the sound determination module 123 sends a warning message to the warning device 130 to notify the caregiver or relevant unit to check. Conversely, if in step 240 it is determined that the cumulative bathroom-usage number is not less than the bathroom-usage threshold value, meaning the bathroom is used at least once within five hours and thus the cared-for person is following his normal living pattern, then in step 250 the sound determination module 123 does not send a warning message to the warning device 130.

Accordingly, the category of sound and the corresponding threshold values used to determine whether a warning message should be issued can be configured differently depending on the monitored environment. For example, if the monitored environment is a bathroom, the category of sound may include clapping sound, body-slapping sound, running water sound, or footsteps sound. If the monitored environment is a bedroom, the category of sound may include snoring sound or turning over sound. Therefore, if the expected sounds in a specific environment are not detected within a certain time range, that is, the number of the expected sound is less than a preset threshold, it is determined that the user is not following his normal living pattern, indicating an abnormal condition. In addition, if a category of sound that is not expected to occur in the monitored environment, for example, a knocking sound in a bathroom or a collision sound in a bedroom, and such a sound occurs within a certain time range with a frequency exceeding a preset threshold, it is determined that the user may be experiencing an abnormal situation. Thus, this invention can determine that a user may be experiencing a sudden incident based on the detection of sound categories that should not occur in the monitored environment, and issue a warning message. Furthermore, when the user encounters a sudden incident, such as falling unconscious and being unable to make sounds or move their limbs, the system can also issue a warning message based on the absence, within a certain time frame, of expected routine sound categories that are typically present in the monitored environment. This allows for more comprehensive protection of the user. Additionally, since the system captures ambient sounds, and sound signals propagate without blind spots, the system can be installed anywhere within the user's environment, thereby providing broader and more effective coverage and protection.

Thus, the foregoing description has been presented for purposes of illustration only. It is not exhaustive and is not limiting to the precise forms or embodiments disclosed. Modifications and adaptations will be apparent to those skilled in the art from consideration of the specification and practice of the disclosed embodiments.

The claims are to be interpreted broadly based on the language employed in the claims and not limited to examples described in the present specification, which examples are to be construed as non-exclusive. Further, the steps of the disclosed methods may be modified in any manner, including by reordering steps and/or inserting or deleting steps.

It will be apparent to those skilled in the art that various modifications and variations can be made to the structure of the present disclosure without departing from the scope or spirit of the disclosure. In view of the foregoing, it is intended that the present disclosure cover modifications and variations of this invention provided they fall within the scope of the following claims and their equivalents.

What is claimed is:

1. An abnormal event detection system, comprising:
a sound capturing device, configured to capture ambient sounds in an area;
an abnormal event processing device coupled to the sound capturing device, configured to recognize the ambient sounds to determine whether the ambient sounds include at least one first sound category that should not occur in the area, and whether the ambient sounds do not include at least one second sound category that should occur in the area; and
a warning device coupled to the abnormal event processing device, wherein when the ambient sounds include the at least one first sound category or do not include the at least one second sound category, the abnormal event processing device controls the warning device to generate a warning message.

2. The abnormal event detection system according to claim 1, wherein the warning message is an alarm sound, an alarm text, an alarm image, an alarm vibration or an alarm flash, and
wherein the warning device is a speaker for outputting the alarm sound, a screen for displaying the alarm text or the alarm image, a vibrator for outputting the alarm vibration, or an indicator light for emitting the alarm flash.

3. The abnormal event detection system according to claim 1, wherein the sound capturing device is a microphone.

4. The abnormal event detection system according to claim 1, wherein the abnormal event processing device further comprises:
a sound filtering module coupled to the sound capturing device, configured to receive and filter the ambient sounds to generate filtered ambient sounds;
a sound recognition module coupled to the sound filtering module, configured to recognize the filtered ambient sounds to generate a plurality of sound categories; and
a sound determination module coupled to the sound recognition module, configured to determine whether the plurality of sound categories include the at least one first sound category, and whether the plurality of sound categories do not include the at least one second sound category.

5. The abnormal event detection system according to claim 4, wherein the sound determination module is further configured to calculate a cumulative number of occurrences of each of the plurality of sound categories within a time range.

6. The abnormal event detection system according to claim 5, wherein the time range further comprises a first time range and a second time range, and the sound determination module is further configured to calculate the cumulative number of occurrences of the at least one first sound category within the first time range and the cumulative number of occurrences of the at least one second sound category within the second time range.

7. The abnormal event detection system according to claim 6, wherein the sound determination module is further configured to determine whether the cumulative number of occurrences of the at least one first sound category within the first time range is greater than a first threshold value; and
when the cumulative number of occurrences of the at least one first sound category within the first time range is greater than the first threshold value, the abnormal event processing device controls the warning device to generate the warning message.

8. The abnormal event detection system according to claim 6, wherein the sound determination module is further configured to determine whether the cumulative number of occurrences of the at least one second sound category within the second time range is less than a second threshold value; and
when the cumulative number of occurrences of the at least one second sound category within the second time range is less than the second threshold value, the sound determination module determines that the plurality of sound categories do not include the at least one second sound category, and the abnormal event processing device controls the warning device to generate the warning message.

9. An abnormal event detection method, comprising:
capturing ambient sounds in an area;
filtering the ambient sounds to generate filtered ambient sounds;
recognizing the filtered ambient sounds to generate a plurality of sound categories;
determining whether the plurality of sound categories include at least one first sound category and whether the plurality of sound categories do not include at least one second sound category; and
generating a warning message when the plurality of sound categories include the at least one first sound category or the plurality of sound categories do not include the at least one second sound category.

10. The abnormal event detection method according to claim 9, further comprising calculating a cumulative number of occurrences of each of the plurality of sound categories within a time range.

11. The abnormal event detection method according to claim 10, wherein the time range further comprises a first time range and a second time range, and the method further comprises calculating the cumulative number of occurrences of the at least one first sound category within the first time range and calculating the cumulative number of occurrences of the at least one second sound category within the second time range.

12. The abnormal event detection method according to claim 11, further comprising:
determining whether the cumulative number of occurrences of the at least one first sound category within the first time range is greater than a first threshold value; and
generating the warning message when the cumulative number of occurrences of the at least one first sound category within the first time range is greater than the first threshold value.

13. The abnormal event detection method according to claim 11, further comprising:
determining whether the cumulative number of occurrences of the at least one second sound category within the second time range is less than a second threshold value; and
determining that the plurality of sound categories do not include the at least one second sound category and generating the warning message when the cumulative number of occurrences of the at least one second sound category within the second time range is less than the second threshold value.

14. An abnormal event processing device, comprising:
a storage circuit configured to store a plurality of computer-executable instructions; and
a processor electrically coupled to the storage circuit, wherein the processor is configured to retrieve and execute the plurality of computer-executable instructions to:
receive ambient sounds in an area;
filter the ambient sounds to generate filtered ambient sounds;
recognize the filtered ambient sounds to generate a plurality of sound categories;
determine whether the plurality of sound categories include at least one first sound category and whether the plurality of sound categories do not include at least one second sound category; and
generate a warning message when the plurality of sound categories include the at least one first sound category or do not include the at least one second sound category.

15. The abnormal event processing device according to claim 14, wherein the processor is further configured to calculate a cumulative number of occurrences of each of the plurality of sound categories within a time range.

16. The abnormal event processing device according to claim 15, wherein the time range further comprises a first time range and a second time range, and the processor is further configured to calculate the cumulative number of occurrences of the at least one first sound category within the first time range and calculate the cumulative number of occurrences of the at least one second sound category within the second time range.

17. The abnormal event processing device according to claim 16, wherein the processor is further configured to:
determine whether the cumulative number of occurrences of the at least one first sound category within the first time range is greater than a first threshold value; and
generate the warning message when the cumulative number of occurrences of the at least one first sound category within the first time range is greater than the first threshold value.

18. The abnormal event processing device according to claim 16, wherein the processor is further configured to:
determine whether the cumulative number of occurrences of the at least one second sound category within the second time range is less than a second threshold value; and
determine that the plurality of sound categories do not include the at least one second sound category and generate the warning message when the cumulative number of occurrences of the at least one second sound category within the second time range is less than the second threshold value.
